(19) United States
(12) Patent Application Publication
(10) Pub. No.: US 2005/0254703 A1
(43) Pub. Date: Nov. 17, 2005

(54) Image capture for three-dimensional display of the image

(75) Inventor: Dinesh K. Jindal, Naperville, IL (US)

Correspondence Address: DUFT BORNSEN & FISHMAN, LLP, 1526 SPRUCE STREET, SUITE 320, BOULDER, CO, 80302, US

(73) Assignee: Lucent Technologies Inc.

(21) Appl. No.: 10/843,172

(22) Filed: May 11, 2004

(51) Int. Cl. G06K 9/00

(52) U.S. Cl. 382/154

(57) ABSTRACT

A method and camera system for capturing a scene in three-dimensional format is described. In the camera system, light sensitive elements receive light reflected off of a scene, and measure properties of the light. The X-Y coordinate system then scans the light sensitive elements an X-Y coordinate to measure X-Y coordinate information for the X-Y coordinate. The Z coordinate system measures Z coordinate information for the corresponding X-Y coordinate. The Z coordinate system measures the Z coordinate information by transmitting waves at the X-Y coordinate of the scene and receiving the waves reflected from the X-Y coordinate. The information system receives the X-Y coordinate information and the Z coordinate information from the X-Y coordinate system and the Z coordinate system respectively, and combines the X-Y coordinate information and the Z coordinate information to generate an image signal.

### BACKGROUND OF THE INVENTION

1. Field of the Invention

The invention is related to the field of image capture, and in particular, to capturing image information for three-dimensional display.

2. Statement of the Problem

Many devices are used to capture images of a scene, such as cameras and camcorders. In a traditional film camera, a lens is directed at a particular scene to be recorded. The lens collects beams of light reflected off of objects in the scene and projects the light beams onto a film to capture a real image of the scene. In a digital camera, the lens projects the light beams onto a semiconductor sensor instead of film. The sensor captures the image of the scene and generates an electronic signal representing the image. A camcorder, or any other type of non-still frame camera, works in essentially the same manner by capturing multiple images over time.

One problem with current cameras and camcorders is that they capture images of a three-dimensional scene in two-dimensional format. For example, in a camcorder, the lens collects light beams representing the image of the scene, and projects the light beams onto a sensor that includes of an array of light sensitive elements. Regardless of whether the camcorder uses Selenium cells (as in early days), an electron tube, charge-coupled devices, or digital and high definition technologies to capture the images, an X-Y coordinate system in the camcorder scans these light sensitive elements to measure the properties (light intensity, color, etc.) of the light for the image going from left to right as well from top to bottom (in interlaced capture it may collect all odd rows first and then all even rows to complete one entire image in two full scans). The properties of different X-Y coordinates are measured over time to produce X-Y coordinate information. Re-displaying these properties on a conventional two-dimensional display (TV monitor) over time at the same rate and the same protocol as was captured will reproduce the same image.

Unfortunately, the camcorder only captures X-Y coordinate information that can be used to display a two-dimensional image of the scene. The depth perspective of the scene is lost when the image is captured by the camcorder.

### SUMMARY OF THE SOLUTION

The invention solves the above and other problems by capturing Z coordinate information of a scene in addition to capturing X-Y coordinate information so that a three-dimensional image of the scene may be captured. Advantageously, the X-Y-Z coordinate information may subsequently be used to display the scene in real three-dimensional format. The image displayed in three-dimensional format more accurately portraits the original scene, which gives a person a better visual experience.

One embodiment of the invention comprises a camera system used to capture a scene in three-dimensional format. The camera system is comprised of a Z coordinate system, light sensitive elements, an X-Y coordinate system, and an information system. When in operation, the light sensitive elements receive light reflected off of a scene. The light sensitive elements measure properties of the light. The X-Y coordinate system then scans the light sensitive elements for one or more X-Y coordinates of the scene to measure X-Y coordinate information for the X-Y coordinates. The Z coordinate system measures Z coordinate information for corresponding X-Y coordinates. The Z coordinate system measures the Z coordinate information by transmitting waves at one or more of the X-Y coordinates of the scene and receiving the waves reflected from the X-Y coordinates of the scene. The information system receives the X-Y coordinate information and the Z coordinate information from the X-Y coordinate system and the Z coordinate system respectively, and combines the X-Y coordinate information and the Z coordinate information to generate an image signal.

In one embodiment of the invention, the Z coordinate system is controlled by the X-Y coordinate system. For a particular X-Y coordinate of the scene, the X-Y coordinate system instructs the Z coordinate system to measure the depth (e.g., Z coordinate information) of the X-Y coordinate. In another embodiment, the camera system further includes a control system that controls both the X-Y coordinate system and the Z coordinate system. The control system instructs the X-Y coordinate system to measure X-Y coordinate information for a particular X-Y coordinate of the scene, and instructs the Z coordinate system to measure the depth of the same X-Y coordinate.

The invention may include other exemplary embodiments described below.

### DESCRIPTION OF THE DRAWINGS

The same reference number represents the same element on all drawings.

FIG. 1A illustrates a camera system in a first exemplary embodiment of the invention.

FIG. 1B illustrates a camera system in a second exemplary embodiment of the invention.

FIG. 2 is a flow chart illustrating a method of operating the camera systems of FIG. 1A or 1B in an exemplary embodiment of the invention.

FIG. 3 illustrates a video network in an exemplary embodiment of the invention.

### DETAILED DESCRIPTION OF THE INVENTION

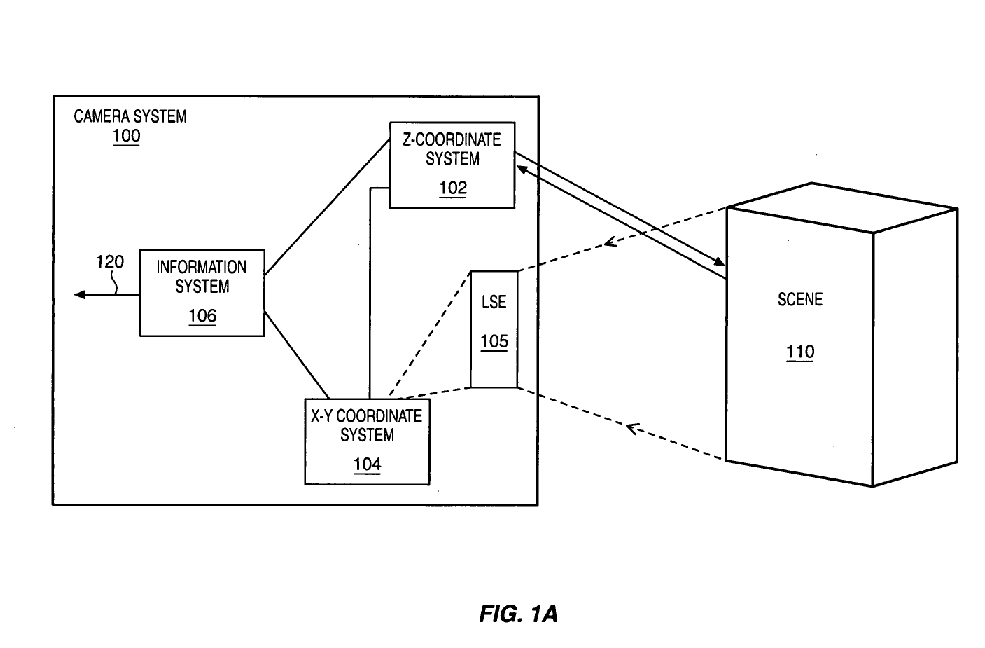

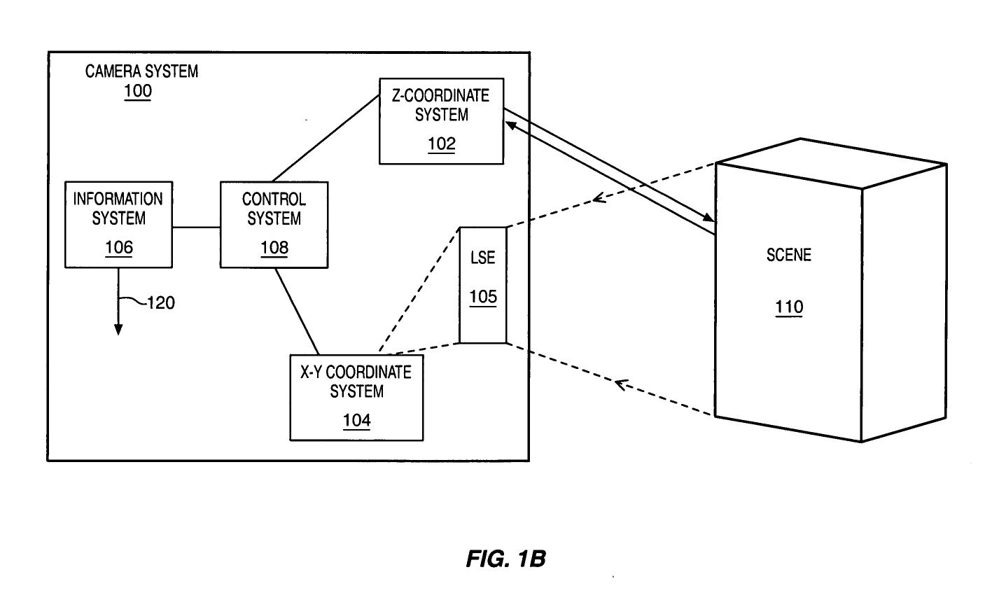

FIGS. 1A, 1B, and 2-3 as well as the following description depict specific exemplary embodiments of the invention to teach those skilled in the art how to make and use the best mode of the invention. For the purpose of teaching inventive principles, some conventional aspects of the invention have been simplified or omitted. Those skilled in the art will appreciate variations from these embodiments that fall within the scope of the invention. Those skilled in the art will appreciate that the features described below can be combined in various ways to form multiple variations of the invention. As a result, the invention is not limited to the specific embodiments described below, but only by the claims and their equivalents.

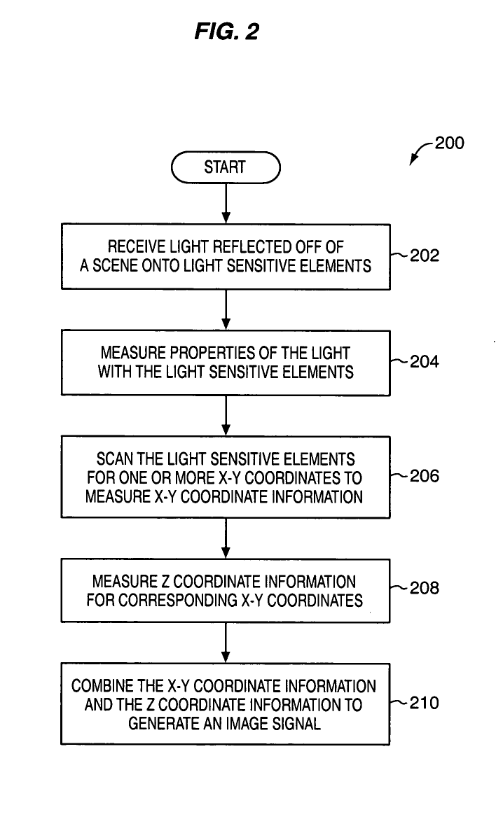

Camera System Configuration and Operation—FIGS. 1A, 1B, and 2

FIG. 1A illustrates a camera system 100 in an exemplary embodiment of the invention. Camera system 100 includes a Z coordinate system 102, an X-Y coordinate system 104, light sensitive elements 105, and an information system 106. Z coordinate system 102 and X-Y coordinate system 104 are coupled to information system 106. Camera system 100 may include other components, devices, or systems not shown in FIG. 1A. In FIG. 1A, camera system 100 is aimed or is pointing at a scene 110 to be captured.

A Z coordinate system comprises any system, device, or component that determines information on a Z coordinate for a corresponding X-Y coordinate. One example of a Z coordinate system includes a radar system that transmits radio waves and measures the time needed for the radio waves to travel from the radar system to a point and back. An X-Y coordinate system comprises any system, device, or component that determines information on an X-Y coordinate for a scene. Light sensitive elements comprise any components or sensors that detect properties of light. An information system comprises any system that combines Z coordinate information and X-Y coordinate information.

FIG. 2 is a flow chart illustrating a method 200 of operating camera system 100 to capture three-dimensional information for the scene 110 in an exemplary embodiment of the invention. In step 202, light sensitive elements 105 receive light reflected off of the scene 110. Light sensitive elements 105 measure properties of the light in step 204. The properties of light may include information on the intensity of light, information on the color of light, etc. In step 206, X-Y coordinate system 104 scans light sensitive elements 105 for one or more X-Y coordinates of the scene 110 to measure X-Y coordinate information for the X-Y coordinates as a function of time. An X-Y coordinate of the scene 110 comprises any position, area, or location on scene 110. The X-Y coordinates of the scene 110 may be referenced by X-Y coordinate values when the image of the scene 110 is projected onto a flat element. For instance, light sensitive elements 105 may comprise an array. When the image (i.e., the light) of the scene 110 is projected onto light sensitive elements 105, the X-Y coordinates of the scene 110 correspond with one or more of the light sensitive elements in the array. The light sensitive elements of the array have X-Y coordinate values that may be used to assign X-Y coordinate values to the X-Y coordinates of the scene 110. When X-Y coordinate system 104 determines the X-Y coordinate information, X-Y coordinate system 104 transmits the X-Y coordinate information to information system 106.

In FIG. 1A, X-Y coordinate system 104 may control Z coordinate system 102. X-Y coordinate system 104 instructs Z coordinate system 102 to measure Z coordinate information (e.g., depth information) for the corresponding X-Y coordinate of the scene 110. Responsive to the control by X-Y coordinate system 104, Z coordinate system 102 measures Z coordinate information for corresponding X-Y coordinates. Z coordinate system 102 measures the Z coordinate information by transmitting waves at one or more of the X-Y coordinates of the scene 110. The waves may be radio waves, microwaves, light/laser waves, etc. Z coordinate system 102 may focus the waves at a particular X-Y coordinate or in the vicinity of a particular X-Y coordinate. Z coordinate system 102 receives the waves reflected from the X-Y coordinates of the scene 110 to determine Z coordinate information for corresponding X-Y coordinates, in step 208. The Z coordinate information may include information on the distance from camera system 100 to an X-Y coordinate, such as in feet, meters, or another measure. Z coordinate system 102 may determine the Z coordinate information by measuring the time needed for the waves to travel from Z coordinate system 102 to an X-Y coordinate of the scene 110 and back. Z coordinate system 102 may determine the Z coordinate information simultaneously as X-Y coordinate system 104 is determining the X-Y coordinate information. Z coordinate system 102 and X-Y coordinate system 104 may be synchronized such that Z coordinate system 102 determines Z coordinate information for a particular X-Y coordinate of the scene 110 simultaneously as X-Y coordinate system 104 determines X-Y coordinate information for the same X-Y coordinate. When Z coordinate system 102 determines the Z coordinate information, Z coordinate system 102 transmits the Z coordinate information to information system 106. Z coordinate system 102 may transmits the Z coordinate information first to X-Y coordinate system 104, which transmits the Z coordinate information to information system 106.

Information system 106 receives the X-Y coordinate information and the Z coordinate information. In step 210, information system 106 combines the X-Y coordinate information and the Z coordinate information to generate an image signal 120. The image signal 120 includes the X-Y-Z coordinate information.

Camera system 100 may be a still-frame camera or a video camera depending on the desired implementation. For a still-frame camera, the image signal 120 includes X-Y-Z coordinate information for a single time period. For a video camera, the image signal 120 includes X-Y-Z coordinate information for multiple time periods.

FIG. 1B illustrates camera system 100 in another exemplary embodiment of the invention. In FIG. 1B, camera system 100 further includes a control system 108 coupled to X-Y coordinate system 104 and Z coordinate system 102. A control system comprises any system that initiates both X-Y coordinate system 104 and Z coordinate system 102 to measure X-Y coordinate information and Z coordinate information, respectively. Control system 108 also ensures that both coordinate systems 102 and 104 are using the same protocols to refer to the same X-Y and Z coordinates at the same time.

When in operation, camera system 100 of FIG. 1B operates substantially as described above. One difference between camera system 100 of FIG. 1B and camera system 100 of FIG. 1A is that control system 108 instructs X-Y coordinate system 104 to measure X-Y coordinate information for a particular X-Y coordinate of the scene 110. Also, control system 108 instructs Z coordinate system 102 to measure Z coordinate information (e.g., depth information) for the corresponding X-Y coordinate of the scene 110. Control system 108 receives Z coordinate information and X-Y coordinate information from Z coordinate system 102 and X-Y coordinate system 104, respectively. Control system 108 then transmits the X-Y-Z coordinate information to information system 106.

X-Y coordinate system 104, Z coordinate system 102, control system 108, and information system 106 may be partially or totally comprised of hardware components. Similarly, X-Y coordinate system 104, Z coordinate system 102, control system 108, and information system 106 may be partially comprised of instructions that are stored on storage media. The instructions can be retrieved and executed by a processor. Some examples of instructions are software, program code, and firmware. Some examples of storage media are memory devices, tape, disks, integrated circuits, and servers. The instructions are operational when executed by the processor to direct the processor to operate in accordance with the invention. The term “processor” refers to a single processing device or a group of inter-operational processing devices. Some examples of processors are computers, integrated circuits, and logic circuitry. Those skilled in the art are familiar with instructions, processors, and storage media.

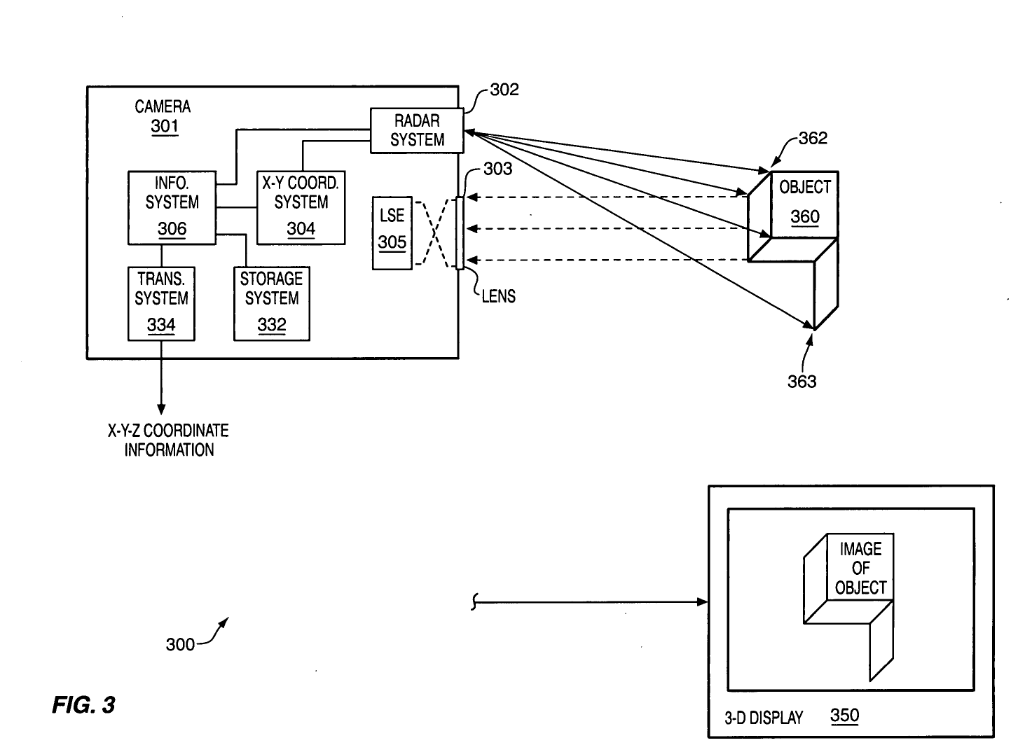

Video Network—FIG. 3

FIG. 3 illustrates a video network 300 in an exemplary embodiment of the invention. Video network 300 includes a camera 301 and a three-dimensional (3-D) display 350. Camera 301 includes a radar system 302, a lens 303, an X-Y coordinate system 304, light sensitive elements 305, an information system 306, a storage system 332, and a transmission system 334. Radar system 302 and X-Y coordinate system 304 are coupled to information system 306. Information system 306 is coupled to storage system 332 and transmission system 334. Camera 301 may comprise a digital camera, a camcorder, a TV camera, a video camera, or any other electronic-type camera. Camera 301 may include other components, devices, or systems not shown in FIG. 3. One or both of storage system 332 and transmission system 334 may be external to camera 301.

In operation, camera 301 is aimed or pointed at 3-D object 360 which is shaped like a cube with extended base. Lens 303 collects light reflecting off of object 360 (the light is illustrated in FIG. 3 as dotted arrows). Lens 303 may be a telephoto lens, a wide-angle lens, a zoom lens, etc. Lens 303 projects the collected light onto light sensitive elements 305. The collected light that is projected onto light sensitive elements 305 is an image of object 360.

Light sensitive elements 305 comprise any semiconductor sensor or other components that measure properties of light, such as a Charge Coupled Device (CCD). Light sensitive elements 305 measure properties of light based on the image of object 360 that is projected onto light sensitive elements 305. X-Y coordinate system 304 scans light sensitive elements 305 for X-Y coordinates of object 360 to measure X-Y coordinate information for the X-Y coordinates of object 360. The X-Y coordinates of object 360 depend on particular implementations. For instance, the X-Y coordinates of object 360 may correspond with a typical display (such as 3-D display 350) that will subsequently be used to display object 360. In such a case, a first X-Y coordinate corresponds with a first pixel on the display, a second X-Y coordinate corresponds with a second pixel on the display, etc. Thus, the number of X-Y coordinates designated for object 360 may depend on the resolution of the display.

For each X-Y coordinate of object 360 for which X-Y coordinate system 304 measures X-Y coordinate information, X-Y coordinate system 304 transmits an instruction to radar system 302 to determine Z coordinate information (e.g., depth information). Responsive to the instruction identify a particular X-Y coordinate of object 360, radar system 302 focuses and transmits radio waves at that X-Y coordinate of object 360. Radar system 302 then measures the time between transmitting the radio waves and receiving the waves reflected off of the X-Y coordinate. Radar system 302 can then determine the distance from radar system 302 to the X-Y coordinate to determine Z coordinate information for the X-Y coordinate. Radar system 302 then transmits the Z coordinate information for the X-Y coordinate much like X-Y coordinate system 304 transmits X-Y coordinate information for the same X-Y coordinate.

As an example, if X-Y coordinate system 304 determines X-Y coordinate information for X-Y coordinate 362 on object 360, then radar system 302 transmits radio waves toward X-Y coordinate 362 to determine Z coordinate information for X-Y coordinate 362. Using the speed of light as C(3*10\hat{ }10 cm/sec), if total time taken for the radio wave to travel from radar system 302 to X-Y coordinate 362 and back was t seconds, then the distance would be t/2*c cms. If radar system 302 does not receive radio waves back after a predefined maximum timeout period, then radar system 302 may assume a predetermined distance for X-Y coordinate 362 depending upon the maximum resolution. As an example, assuming NTSC system with 525 lines per frame, 60 frames per second, and 100 points per line, radar system 302 needs 1/(525*60*100) seconds to cover each X-Y coordinate. Light can cover a distance of 3*10\hat{ }10/(525*60*100) cm or ˜9500 cms which is twice the distance traveled. Thus, radar system 302 can differentiate the depth of objects that are no more than ˜47 meters away and max timeout being 1/(525*60*100) seconds. If radar system 302 doesn't receive the radio waves back within this time, radar system 302 assumes that the X-Y coordinate is 50 meters deep.

If X-Y coordinate system 304 determines X-Y coordinate information for X-Y coordinate 363 on object 360, then radar system 302 transmits radio waves toward X-Y coordinate 363 to determine Z coordinate information for X-Y coordinate 363. Radar system 302 does this for each X-Y coordinate so that information system 306 receives Z coordinate information for each X-Y coordinate.

In other embodiments, radar system 302 may determine Z coordinate information for a subset of the X-Y coordinates of object 360. X-Y coordinates of object 360 may be tenths of millimeters apart depending on the resolution of camera 301. This type of resolution may not be needed to reproduce a 3-D image. Radar system 302 may assume that two or more conjoining X-Y coordinates may have approximately the same Z coordinate information. Consequently, radar system 302 may determine Z coordinate information for every fourth, fifth, sixth, tenth, twentieth X-Y coordinate, etc, depending on the desired resolution.

Information system 306 receives X-Y coordinate information and Z coordinate information for each (or substantially each) X-Y coordinate of object 360. Information system 306 combines or synchronizes the information to generate an image signal that includes the X-Y-Z coordinate information for each X-Y coordinate. If camera 301 is a digital camera, or another type of still-frame camera, then the image signal includes X-Y-Z coordinate information for a single time period. If camera 301 is a camcorder, or other video-type camera, then the image signal includes X-Y-Z coordinate information for multiple time periods.

The purpose for capturing the image of object 360 is to record the image and subsequently play it back. Thus, information system 306 may transmit the image signal to storage system 332 to store the image signal. Storage system 332 may comprise a hard drive, a DVD, a tape or any other magnetic memory or optical memory. Information system 306 may also transmit the image signal to transmission system 334. Responsive to receiving the image signal, transmission system 334 transmits the image signal (that includes the X-Y-Z coordinate information) to an external system or network (not shown). Transmission system 334 may communicate via wireline signals (electrical or optical) or wireless signals (satellite, radio, cellular, etc).

If 3-D display 350 receives the image signal, then 3-D display 350 processes the X-Y-Z coordinate information to display one or more images of object 360. 3-D display 350 comprises any display, monitor, or TV that displays real three-dimensional images. 3-D display 350 is not a traditional two-dimensional display, but is truly able to display images in three-dimensions. One example of a 3-D display is described in U.S. Pat. No. 5,801,666, which is incorporated by reference to the same extent as if fully set forth herein. 3-D display 350 may be for a television, a computer monitor, a PDA, a phone, a calculator, or any other device utilizing a display.

Based on the information captured by camera 301, 3-D display 350 is able to display a 3-D image of object 360. More particularly, because camera 301 is able to capture Z coordinate information for object 360, the depth perspective of viewing object 360 is not lost, and 3-D display 350 is able to provide a more realistic image of object 360 than was previously provided.

1. A camera system, comprising:
an information system;
light sensitive elements that receive light reflected off of a scene and measure properties of the light;
an X-Y coordinate system that scans the light sensitive elements for an X-Y coordinate of the scene to measure X-Y coordinate information for the X-Y coordinate, and transmits the X-Y coordinate information to the information system; and
a Z coordinate system that measures Z coordinate information for the corresponding X-Y coordinate by transmitting waves toward the X-Y coordinate of the scene and receiving the waves reflected from the X-Y coordinate, and transmits the Z coordinate information to the information system;
the information system receives the X-Y coordinate information and the Z coordinate information and combines the X-Y coordinate information and the Z coordinate information to generate an image signal.

2. The camera system of claim 1 wherein the Z coordinate system generates the Z coordinate information by measuring the time needed for the waves to travel from the Z coordinate system to the X-Y coordinate of the scene and return to the Z coordinate system.

3. The camera system of claim 1 wherein the X-Y coordinate system scans the light sensitive elements from left to right and from top to bottom.

4. The camera system of claim 1 further comprising:
a lens that collects light reflected off of the scene and projects the light onto the light sensitive elements.

5. The camera system of claim 1 wherein the X-Y coordinate system instructs the Z coordinate system to measure Z coordinate information for the X-Y coordinate.

6. The camera system of claim 1 further comprising:
a control system that instructs the X-Y coordinate system to measure X-Y coordinate information for the X-Y coordinate, and instructs the Z coordinate system to measure Z coordinate information for the X-Y coordinate.

7. The camera system of claim 1 wherein the Z coordinate system measures the Z coordinate information for the X-Y coordinate simultaneously as the X-Y coordinate system measures the X-Y coordinate information for the X-Y coordinate.

8. The camera system of claim 1 further comprising:
a storage system that receives the image signal and stores the X-Y coordinate information and the Z coordinate information.

9. The camera system of claim 1 further comprising:
a transmission system that transmits the image signal to external systems.

10. The camera system of claim 1 further comprising:
a display system that receives the X-Y coordinate information and the Z coordinate information and displays an image of the scene in three dimensional format based on the X-Y coordinate information and the Z coordinate information.

11. A method of capturing a three-dimensional image, the method comprising the steps of:
receiving light reflected off of a scene onto light sensitive elements and measuring properties of the light;
scanning the light sensitive elements for an X-Y coordinate of the scene to measure X-Y coordinate information for the X-Y coordinate;
measuring Z coordinate information for the corresponding X-Y coordinate by transmitting waves toward the X-Y coordinate and receiving the waves reflected from the X-Y coordinate; and
combining the X-Y coordinate information and the Z coordinate information to generate an image signal.

12. The method of claim 11 wherein the step of measuring the Z coordinate information comprises:
measuring the time needed for the waves to travel to the X-Y coordinate of the scene and back.

13. The method of claim 11 wherein the step of scanning the light sensitive elements comprises:
scanning the light sensitive elements from left to right and from top to bottom.

14. The method of claim 11 further comprising the steps of:
collecting the light reflected off of the scene with a lens; and
projects the light from the lens onto the light sensitive elements.

15. The method of claim 11 wherein the step of measuring Z coordinate information comprises:
measuring Z coordinate information for the X-Y coordinate responsive to an instruction.

16. The method of claim 11 wherein:
the step of measuring X-Y coordinate information comprises measuring X-Y coordinate information for the X-Y coordinate responsive to an instruction from a control system; and
the step of measuring Z coordinate information comprises measuring Z coordinate information for the X-Y coordinate responsive to an instruction from the control system.

17. The method of claim 11 wherein the step of measuring the Z coordinate information for the X-Y coordinate is performed simultaneously as the step of measuring the X-Y coordinate information for the X-Y coordinate.

18. The method of claim 11 further comprising the step of:
receiving the image signal and storing the X-Y coordinate information and the Z coordinate information.

19. The method of claim 11 further comprising the step of:
transmitting the image signal to external systems.

20. The method of claim 11 further comprising the steps of:
receiving the X-Y coordinate information and the Z coordinate information and displaying an image in three dimensional format based on the X-Y coordinate information and the Z coordinate information.
